(19) United States
(12) Patent Application Publication
(10) Pub. No.: US 2023/0133197 A1
(43) Pub. Date: May 4, 2023

(54) RESIN-BASED ELECTRONIC PARKING BRAKE PISTONS, METHODS OF MAKING SAID PISTONS, AND METHODS OF USING SAID PISTIONS

(71) Applicant: Court Holdings Limited, Ontario (CA)

(72) Inventor: Mark FAWCETT, Grimsby (CA)

(73) Assignee: Court Holdings Limited, Ontario (CA)

(21) Appl. No.: 17/930,855

(22) Filed: Sep. 9, 2022

Related U.S. Application Data
(60) Provisional application No. 63/273,609, filed on Oct. 29, 2021.

(51) Int. Cl. F16D 65/18

(52) U.S. Cl. CPC F16D 65/18; F16D 2125/40

(57) ABSTRACT

Resin-based electronic parking brake pistons, methods of making said pistons, and methods of using said pistons are disclosed, wherein each piston has a piston body made of a sole synthetic polymer material consisting of at least one reaction product obtained by reacting at least one formaldehyde with at least one phenol and/or at least one substituted phenol. Each piston may also have an internal contact area disposed in an interior of the piston body and configured to contact at least one spindle nut of at least one electromechanical parking brake system and/or an outer surface disposed on an exterior of the piston body and configured to be slidable within at least one caliper bore of at least one electromechanical parking brake system.

This non-provisional application claims priority from U.S. provisional application Ser. No. 63/273,609, filed Oct. 29, 2021, which is incorporated herein by reference in its entirety.

### FIELD OF THE DISCLOSURE

This disclosure generally relates to the field of electronic braking systems and resin-based electronic brake pistons (hereinafter “EPB”). More specifically, this disclosure is directed to phenolic-based electronic parking brake and/or full-phenolic electronic parking brake (collectively referred to hereinafter “FP-EPB”) pistons for electronic braking systems and/or mechanical and/or electromechanical brake calipers. The FP-EPB pistons disclosed herein may be made of and/or formed from at least one resin- or phenolic-based synthetic polymer. As a result, the FP-EPB pistons may unexpectedly and surprisingly achieve reduced weights associated with electronic braking systems and/or eliminate or substantially eliminate corrosion of the electronic braking systems.

### BACKGROUND

The statements in this section merely provide background information related to the present disclosure and do not constitute prior art.

During a standard brake apply in a disc brake system, hydraulic fluid is pressurized, which causes the brake pistons to move the brake pads against brake rotors, creating a clamping force. The clamping force functions to decelerate and/or restrict movement of the vehicle. Releasing the brake, releases the clamp force and the fluid is depressurized. As a result, the brake pistons and brake pads move away from the brake rotor; once released, the vehicle is free to move again.

A parking brake system may utilize one or more components of the brake system to maintain a vehicle in a stopped or parked position. In modern applications, the parking brake systems may be mechanical or adopt an electromechanical system. Electromechanical parking brake systems includes a motor gear unit, spindle and nut adapted to move the brake pistons and brake pads against brake rotors to create a clamp force to maintain the vehicle in a stopped or parked position. To release the clamp force, the motor gear unit, spindle, and nut mechanism moves away from the brake piston allowing the brake pistons and brake pads to release the brake rotors.

Traditionally, all mechanical or electromechanical parking brake caliper pistons are made from steel so as to be sufficiently ridged to withstand the required axial and radial forces of the brake fluid through normal brake apply and or through activation of the mechanical or electromechanical parking brake mechanism. As a result, there are issues with the use of steel pistons with this type of electromechanical parking brake caliper, mainly related to weight of the caliper and piston, but more so with corrosion through reduce brake cycles or inactivity when used for electric vehicles (hereinafter “EV”).

No known braking systems utilize engineered resin-based brake pistons for electromechanical parking brake calipers. Therefore, it is an objection of the present disclosure to provide novel and inventive brake pistons capable of reducing weight of said piston, eliminating corrosion of the parking brake system components, and/or increasing stiffness sufficiently to withstand brake actuation forces.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one or more embodiments, the FP-EPB pistons disclosed herein may comprise an engineered resin phenolic body (hereinafter “the body”) having a novel and inventive design layout, that is designed to be a load bearing component and/or configured to apply these loads through the brake pads with at least one outer surface of the body being a movable component that is slidably within the caliper bore and applies braking under hydraulic pressure. In some embodiments, the body of the FP-EPB pistons may be made of or formed from a sole material consisting of at least one phenolic-based synthetic polymer. In at least one embodiment, the sole material of the body may consist of at least one phenol formaldehyde resin, at least one phenolic resin, or at least one combination thereof.

In response to an actuation of the hydraulic brake system, the FP-EPB pistons may slide within the caliper bores and/or apply braking pressures through the brake pads against the brake disks. One or more parking brakes with electromechanical brake systems may comprise one or more motor gear units, one or more spindles, one or more spindle screws, and/or spindle nuts, wherein one or more electric motors may cause at least one spindle to rotate such that at least one spindle nut is forced to engage one or more internal features of the FP-EPB pistons. As a result, engagement of the one or more internal features of the FP-EPB pistons, the FP-EPB pistons may apply force to the brake pads and/or the brake disks.

In one or more embodiments, a resin-based electronic parking brake piston may comprise a piston body made of a sole synthetic polymer material consisting of at least one reaction product obtained by reacting at least one formaldehyde with at least one phenol and/or at least one substituted phenol, and at least one selected from: at least one internal contact area disposed in an interior of the piston body and configured to contact at least one spindle nut of at least one electromechanical parking brake system; and at least one outer surface disposed on an exterior of the piston body and configured to be slidable within at least one caliper bore of at least one electromechanical parking brake system.

In an embodiment, the sole synthetic polymer material of the piston body may be a molding or moldable material.

In an embodiment, the sole synthetic polymer material of the piston body may be a glass filled molding or moldable material, a mineral filled molding or moldable material, or a combination thereof.

In an embodiment, the sole synthetic polymer material of the piston body may be a two stage, glass and mineral filled, molding or moldable material.

In an embodiment, the interior of the piston body may further comprise at least one selected from one or more drive nut anti-rotation features and at least one drive nut contact area.

In an embodiment, the piston body may comprise an open end, a closed end located opposite with respect to the open end, and a wall disposed between the open end and the closed end, and the at least one outer surface is disposed on the wall of the piston body.

In an embodiment, the closed end of the piston body may comprise a piston head and at least one pad contact area configured to contact at least one brake pad of the electromechanical parking brake system.

In an embodiment, the piston body may be shaped and/or sized to be disposed or received within the caliper bore of an electromechanical parking brake system.

In one or more embodiments, a method may comprise at least molding or forming a sole synthetic polymer material into a piston body of a resin-based electronic parking brake piston, wherein the sole synthetic polymer material consists of at least one reaction product obtained by reacting at least one formaldehyde with at least one phenol and/or at least one substituted phenol, and at least one selected from at least one internal contact area and at least one outer surface is/are disposed on the piston body, the at least one internal contact area is configured for contacting at least one spindle nut of at least one electromechanical parking brake system, and the at least one outer surface is adapted to be slidable within at least one caliper bore of at least one electromechanical parking brake system.

In an embodiment, the method may further comprise at least reacting the at least one formaldehyde with the at least one phenol and/or the at least one substituted phenol to obtain the at least one reaction product prior to molding or forming the sole synthetic polymer into the piston body of the resin-based electronic parking brake piston.

In an embodiment, the method may further comprise at least incorporating the resin-based electronic parking brake piston into the electromechanical parking brake system.

In an embodiment, the method may further comprise at least moving the resin-based electronic parking brake piston within a caliper bore of the electromechanical parking brake system.

In an embodiment, the wherein the piston body is shaped and/or sized to be disposed or received within a caliper bore of the electromechanical parking brake system.

In an embodiment, the method may further comprise at least disposing the resin-based electronic parking brake piston within the caliper bore of the electromechanical parking brake system.

In an embodiment, the sole synthetic polymer material is a glass filled molding or moldable material, a mineral filled molding or moldable material, or a combination thereof.

In one or more embodiments, a method may comprise at least disposing a resin-based electronic parking brake piston within a caliper bore of an electromechanical parking brake system, wherein the resin-based electronic parking brake piston may comprise a piston body made of a sole synthetic polymer material consisting of at least one reaction product obtained by reacting at least one formaldehyde with at least one phenol and/or at least one substituted phenol, at least one internal contact area disposed on the piston body and configured for contacting at least one spindle nut of the electromechanical parking brake system, and at least one outer surface disposed on the piston body and configured to be slidable within at least one caliper bore of at least one electromechanical parking brake system.

In an embodiment, the method may further comprise at least contacting the at least one internal contact area with the at least one spindle nut or sliding the piston body within the at least one caliper bore via the at least one outer surface.

In an embodiment, the method may further comprise at least activating or deactivating the resin-based electronic parking brake piston.

In an embodiment, the method may further comprise moving the resin-based electronic parking brake piston within the caliper bore.

In an embodiment, the at least one reaction product is made, produced, or formed from at least one glass filled molding or moldable material, at least one mineral filled molding or moldable material, or at least one combination thereof.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a cross-sectional view of a FP-EPB piston shown and/or disposed within an EPB caliper, according to one or more embodiments of the disclosure.

FIG. 2 illustrates a cross-section view of a FP-EPB piston for the EPB caliper shown in FIG. 1, according to one or more embodiments of the disclosure.

FIG. 3 illustrates a cross-section view of another FP-EPB piston for the EPB caliper shown in FIG. 1, according to one or more embodiments of the disclosure.

FIG. 4 illustrates a cross-section view of yet another FP-EPB piston for the EPB caliper shown in FIG. 1, according to one or more embodiments of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Also, the phrases “selected from the group consisting of,” “chosen from,” and the like include mixtures of the specified materials. Terms, such as, for example, “contains” and the like are meant to include “including at least” unless otherwise specifically noted.

Herein, the term “about” when applied to a value generally means within the tolerance range of the equipment used to produce the value, or in some examples, means plus or minus 10%, or plus or minus 5%, or plus or minus 3%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation. Where a numerical limit or range is stated herein, the endpoints are included. Also, all values and subranges within a numerical limit or range are specifically included as if explicitly written out.

In one or more embodiments, the FP-EPB pistons disclosed herein may be made of, formed from, and/or molded from one or more phenolic-based synthetic polymers and/or phenolic-based resins (collectively referred to hereinafter as “phenolic-based resins”). In some embodiments, the FP-EPB pistons and/or the bodies of the FP-EPB pistons may be made of, formed from, and/or molded from a sole material consisting of the phenolic-based resins. In at least one embodiment, the bodies of the FP-EPB pistons, in their entireties, may be made of, formed from, and/or molded from the phenolic-based resins. The bodies of the FP-EPB pistons disclosed herein comprise novel and inventive structural features and relationships that distinguish the present FP-EPB pistons form traditionally EPB brake pistons manufactured from steel, metal, or a steel or metal material. The FP-EPB pistons disclosed herein may be configured, designed, adapted, shaped, and/or sized to be disposed within and/or received by one or more EPB calipers of one or more EPB systems.

The phenolic-based resins of the bodies of the FP-EPB pistons disclosed herein may be one or more reaction products of one or more reactions of one or more phenols and/or one or more substituted phenols with one or more formaldehydes. In some embodiments, the one or more phenolic-based resins of the bodies disclosed herein may be one or more synthetic polymers produced from and/or obtained by reacting one or more phenols and/or one or more substituted phenols with one or more formaldehydes. In some embodiments, the one or more phenolic-based resins and/or the one or more phenolic resins of the bodies disclosed herein may be one or more thermosetting network polymers directly or indirectly produced by and/or formed from reacting the one or more phenols and/or the one or more substituted phenols with the one or more formaldehydes. In other embodiments, the one or more phenolic-based resins and/or the one or more phenolic resins of the bodies disclosed herein may be produced by and/or formed from one or more novolac prepolymers, producible from the one or more formaldehydes, that may be molded and cured with addition of more formaldehyde(s) and/or heat. In some embodiments, the one or more phenolic-based resins may be filled, substantially filled, or at least partially filed with, for example, at least one glass material, at least one mineral material, or at least one combination thereof. In at least one embodiment, the one or more phenolic-based resins or phenolic resins may be, may comprise, or may consist of at least one two-stage phenolic material. In some embodiments, the at least one two-stage phenolic material may be, may comprise, or may consist of at least one glass filled phenolic material, at least one mineral filled phenolic material, or at least one glass and mineral filled phenolic material.

In one or more embodiments, the piston is molded or moldable or may be molded or moldable such that the strength of the piston to resist radial forces and/or axial forces does not degrade or may not be degradable in the presence of brake fluid and/or in service. In some embodiments, the piston is compression molded or moldable or may be compression molded or compression moldable. The piston may be free or substantially free of elastic material. In at least one embodiment, the piston may be produced from, formed from, and/or made of at least thermoset polymer. In some embodiments, the piston may be made from, formed from, produced by, and/or consist of a material, such as, for example, at least one polymeric material. In at least one embodiment, the material of the piston may be reinforced with one or more fibers. In some embodiments, the one or more fibers may be produced from, formed from, and/or made of one or more glass fillers, one or mineral fillers, or at least one combination thereof. In one or more embodiments, the piston may be produced from, formed from, and/or made from at least one phenolic resin.

A suitable material of the piston may exhibit at least one of the following physical/mechanical/thermal/electrical properties: a pre-molded gravity before baking of about 1.5 or greater, about 1.75 or greater, or about 2.0 or greater, measured using ASTM D792; a typical high filler phenolic thermosets range between about 2.05 to about 2.2, about 2.065 to about 2.175, or about 2.08 to about 2.15; a post baked molded gravity of about 1.5 or greater, about 1.75 or greater, or about 2.0 or greater, measured using ASTM D792; a typical high filler phenolic thermosets range between about 2.07 and about 2.12; a post baked Rockwell Hardness of about 120, about 110, or about 100 minimum E Scale, measured using ASTM D785; a typical high filler phenolic thermosets range between about 102 and about 111; a post baked Compressive Strength of about 420 MPa or less, about 410 MPa or less, or about 400 MPa or less, measured using ASTM D695; a typical high filler phenolic thermosets range between about 265 and about 400, about 270 and about 395, or about 275 and about 390; a post baked Tensile Strength of about 120 MPa or less, about 150 MPa or less, or about 100 MPa or less, measured using ASTM D638; a typical high filler phenolic thermosets range between about 40 and about 110, about 45 and about 105, or about 50 and about 100; a suitable material may have a post-baked Water Aging percentage of weight change of about 0.1% or less, about 0.075% or less, or about 0.05% or less, measured using ASTM D570 for 24 hours at 22-24° C.; a suitable material may having a post-baked Water Aging percentage of volume change of about 0.1% or less, about 0.09% or less, or about 0.08% or less, measured using ASTM D3604 for 24 hours at 22-24° C.; a post baked impact strength of about 30 J/m or less, about 27.5 J/m or less, or about 25 J/m or less, measured using ASTM D256; a post baked Flexural Strength of about 170 MPa or less, about 160 MPa or less, or about 150 MPa or less, measured using ASTM D790; a typical high filler phenolic thermosets range between about 55 and about 145, about 60 and about 140, or about 75 and about 135; a post baked Flexural Modulus of about 70 GPa or less, about 60 GPa or less, or about 50 GPa or less, measured using ASTM D790; a typical high filler phenolic thermosets of about 35 or less, about 30 or less, or about 25 or less; a post baked Deflection Temperature of about 270 ° C. minimum, about 260 ° C. minimum, or about 250° C. minimum, measured using ASTM D648; and/or a typical high filler phenolic thermosets are >about 280° C., >about 290° C., or >about 300° C. In some embodiments, the material of the piston may be originally in granular form or grounded form and/or molded or moldable at a temperature ranging from about 320° F. to about 370° F., about 330° F. to about 360° F., or about 340° F. to about 350° F. In at least one embodiment, the material of the piston may exhibit or achieve all or substantially all of the above-mentioned physical/mechanical/thermal/electrical properties and/or may be a halogen-free material, a phthalate-free material, or a halogen-free and phthalate-free material.

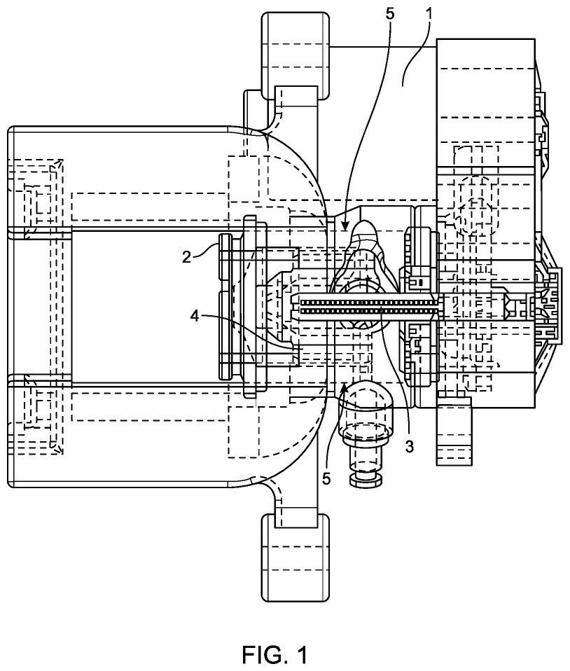

In one or more embodiments, FIG. 1 shows a cross-sectional view of an embodiment of the FP-EPB piston disclosed herein and having one or more of the following structural elements or components: at least one EPB caliper body 1 (hereinafter “EPB caliper body 1”) comprising at least one caliper bore 5 (hereinafter “bore 5”) and/or one or more caliper components; at least one FP-EPB piston 2 (hereinafter “piston 2”); at least one spindle screw 3 (hereinafter “screw 3”); at least one spindle nut 4 (hereinafter “nut 4”); or at least one combination thereof.

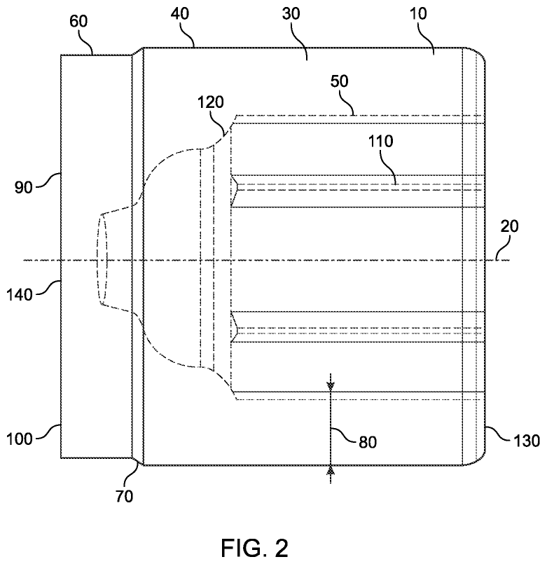

FIGS. 2-4 show cross-sectional views of different embodiments of the FP-EPB pistons (i.e. piston 2) disclosed herein and having and/or comprising one or more of the following structural elements or components: at least one piston body 10 (hereinafter “piston body 10”); a longitudinal axis 20 (hereinafter “longitudinal axis 20”); at least one wall 30 (hereinafter “wall 30”); at least one outer/exterior surface or outside 40 (hereinafter “outside 40”); at least one inner/internal surface or inside 50 (hereinafter “inside 50”); at least one boot groove area 60 (hereinafter “boot groove area 60”); at least one shoulder 70 (hereinafter “shoulder 70”); at least one cross-sectional area 80 (hereinafter “cross-sectional area 80”); at least one piston head 90 (hereinafter “piston head 90”); at least one pad contact area 100 (hereinafter “pad contact area 100”); one or more drive nut anti-rotation features 110 (hereinafter “drive nut anti-rotation features 110”); at least one drive nut contact area 120 (hereinafter “drive nut contact area 120”); at least one open end 130 (hereinafter “open end 130”); at least one closed end 140 (hereinafter “closed end 140”); or at least one combination thereof.

In one or more embodiments, one or more of the structural elements or components of the FP-EPB pistons shown in FIGS. 2-4 may be the same or substantially the same structural elements or components throughout FIGS. 2-4. In some embodiments, one or more of the structural elements or components of the FP-EPB pistons shown in FIGS. 2-4 may provide, achieve, and/or exhibit the same or substantially the same functionality throughout FIGS. 2-4. In at least one embodiment, one or more of the structural elements or components of the FP-EPB pistons shown in FIGS. 2-4 may comprise one or more structural variations amongst each other throughout FIGS. 2-4.

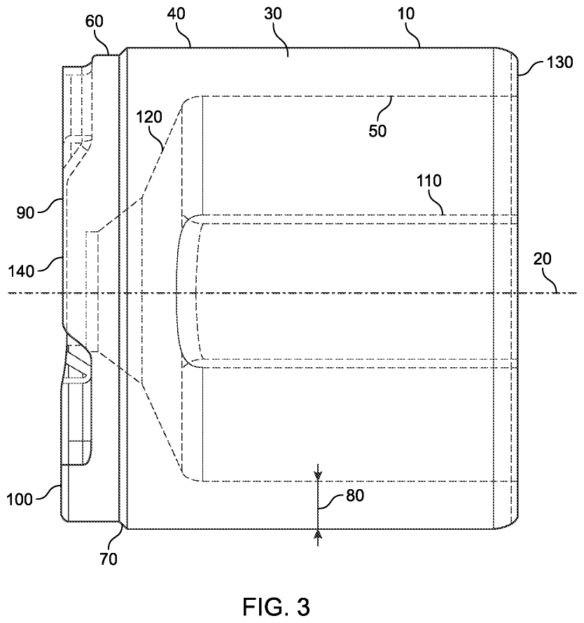

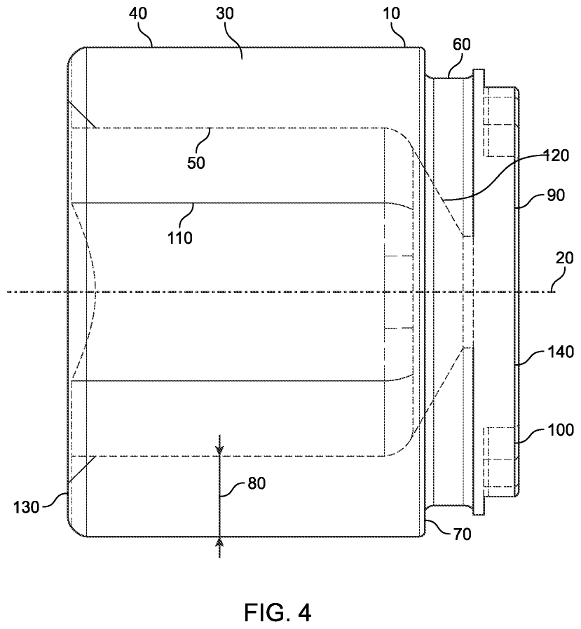

For example, the drive nut contact area 120 may comprise at least one interior surface as shown in FIGS. 2-4 and the at least one interior surface may be or may comprise at least one planar surface, at least one linear surface, at least one non-linear surface, at least one angled surface, at least one curved surface, at least one concaved surface, at least one convex surface, at least one tapered surface, at least one notched surface, at least one undulating surface, or at least one combination therein. In another example, the piston head 90 may be continuous and uninterrupted across the entire closed end 140 (as shown in FIG. 2) or across at least one portion of the closed end 140. In some embodiments, the piston head 90 may comprise one or more notched or recessed portions extending across at least a portion of the closed end 140 (as shown in FIGS. 3 and 4). In yet another example, the boot groove area 60 may comprise at least one planar surface (as shown in FIG. 2), at least one linear surface, at least one non-linear surface, at least one angled surface, at least one curved surface, at least one concaved surface (as shown in FIG. 4, at least one convex surface, at least one tapered surface, at least one notched surface, at least one undulating surface, or at least one combination thereof (as shown in FIG. 3).

In one or more embodiments, one or more external design features and/or internal design features (collectively referred to hereinafter as “piston design features”) of the FP-EPB piston disclosed herein may be based on, configured to, and/or adapted for one or more customer-specific requirements, specifications, and/or design needs to calipers and/or caliper internal components of one or more customers. As a result, the piston design features may be different or similar for each caliper design and/or may change for each and/or every model and/or size. In some embodiment, one or more external design features and/or internal design features (collectively referred to hereinafter as “component design features”) of the one or more FP-EPB piston components (i.e., the EPB caliper body 1, the bore 5, the piston 2, the screw 3, and/or the nut 4″) disclosed herein may be based on, configured to, and/or adapted for one or more customer-specific requirements, specifications, and/or design needs to calipers and/or caliper internal components of one or more customers. As a result, the component design features may be different or similar for each caliper design and/or may change for each and/or model and/or size.

One or more of the above-mentioned structural elements or components (i.e., the EPB caliper body 1, the piston 2, the screw 3, the nut 4, the piston body 10, the longitudinal axis 20, the wall 30, the outside 40, the inside 50, the boot groove area 60, the shoulder 70, the cross-sectional area 80, the piston head 90, the pad contact area 100, the drive nut anti-rotational features 110, the drive nut contact area 120, the open end 130, and/or the closed end 140) illustrated in FIGS. 1-4 may be connected to each other, attached to each other, adjacent to each other, integrally formed together, separately formed, located adjacent with respect to at least one other structural element or component, located opposite with respect at least one other structural element or component, abutting at least one other structural element or component, contacting at least one other structural element or component, movable with respect to at least one other structural element or component, stationary with respect to at least one other structural element or component, coupled to at least one other structural element or component, engaging at least one other structural element or component, separable from at least one other structural element or component, affixed to or inseparable from at least one other structural element or component, or any combination thereof.

As discussed herein and shown throughout FIGS. 1-4, the present EPB systems disclosed herein may comprise at least one brake caliper (i.e., EPB caliper body 1) with a single or multiple bores for accommodating slidable FP-EPB pistons or piston 2 located within the bore 5. The FP-EPB pistons or piston 2 disclosed herein may comprise the piston body 10 which may be fabricated, formed, manufactured, or made from at least one engineered resin being at least one engineered phenolic resin and/or the phenolic-based resin. The piston body 10 may be designed, configured, adapted, shaped, and/or sized to give, provide, and/or achieve excellent or improved hydraulic functionality and/or electromechanical brake functionality.

In one or more embodiments, the present EPB systems disclosed herein may utilize or change hydraulic fluid pressure to cause the FP-EPB piston or piston 2 to slide within the bore 5, apply pressure onto one or more brake pads (not shown in the drawings), and/or push the one or more brake pads against at least one brake rotor (not shown in the drawings). The present EPB systems disclosed herein may use and/or utilize both hydraulic pressure for braking and mechanical and/or electromechanical force(s) as a means of activation of the parking brake system. As a result, the EPB systems disclosed herein may be activated for braking and/or deactivated for movement by hydraulic pressure and mechanical and/or electromechanical force(s) applicable or achievable by the present EPB systems. In some embodiments, the present EPB systems disclosed herein may also comprise at least one of the screw 3 and the nut 4 which may be driven, movable, or operatable by an electric motor (not shown in the drawings).

In some embodiments, the present EPB systems disclosed herein may utilize the electric motor to cause the spindle screw (i.e., screw 3) to rotate and move the spindle nut (i.e., nut 4) in at least one linear motion. As a result of the spindle nut contacting the internal contact area (i.e., drive nut contact area 120) of the piston 2, the applied force may move PF-EPB piston (i.e., piston 2) against the brake pad and rotor and/or may apply the parking brake.

In one or more embodiments, the FP-EPB pistons or piston 2 disclosed herein may be designed, configured, adapted, shaped, and/or sized to accommodate all types of brake calipers. As a result, the present FP-EPB pistons or piston 2 may achieve at least one advantage such as is improved and/or reduce overall weight and/or an improved mass reduction. At least one additional advantage achieved by the FP-EPB pistons or piston 2 disclosed herein may surprisingly be an improved thermal installation when utilizing the present FP-EPB pistons or piston 2. Another additional advantage achievable by the FP-EPB pistons or piston 2 disclosed herein may be an elimination of corrosion for the EPB pistons or piston 2.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A resin-based electronic parking brake piston comprising:
a piston body made of a sole synthetic polymer material consisting of at least one reaction product obtained by reacting at least one formaldehyde with at least one phenol and/or at least one substituted phenol; and
at least one selected from:
at least one internal contact area disposed in an interior of the piston body and configured to contact at least one spindle nut of at least one electromechanical parking brake system; and
at least one outer surface disposed on an exterior of the piston body and configured to be slidable within at least one caliper bore of at least one electromechanical parking brake system.

2. The resin-based electronic parking brake piston of claim 1, wherein the sole synthetic polymer material of the piston body may be at least one molding or moldable material.

3. The resin-based electronic parking brake piston of claim 1, wherein the sole synthetic polymer material of the piston body is at least one glass filled molding or moldable material, at least one mineral filled molding or moldable material, or at least one combination thereof.

4. The resin-based electronic parking brake piston of claim 3, wherein the sole synthetic polymer material of the piston body is at least one two stage, glass and mineral filled, molding or moldable material.

5. The resin-based electronic parking brake piston of claim 1, wherein the interior of the piston body further comprises at least one selected from one or more drive nut anti-rotation features and at least one drive nut contact area.

6. The resin-based electronic parking brake piston of claim 1, wherein the piston body comprises an open end, a closed end located opposite with respect to the open end, and a wall disposed between the open end and the closed end, and the at least one outer surface is disposed on the wall of the piston body.

7. The resin-based electronic parking brake piston of claim 6, wherein the closed end of the piston body comprises a piston head and at least one pad contact area configured to contact at least one brake pad of the electromechanical parking brake system.

8. The resin-based electronic parking brake piston of claim 1, wherein the piston body is shaped and/or sized to be disposed or received within the caliper bore of an electromechanical parking brake system.

9. A method comprising:
molding or forming a sole synthetic polymer material into a piston body of a resin-based electronic parking brake piston, wherein
the sole synthetic polymer material consists of at least one reaction product obtained by reacting at least one formaldehyde with at least one phenol and/or at least one substituted phenol, and
at least one selected from at least one internal contact area and at least one outer surface is/are disposed on the piston body, the at least one internal contact area is configured for contacting at least one spindle nut of at least one electromechanical parking brake system, and the at least one outer surface is adapted to be slidable within at least one caliper bore of at least one electromechanical parking brake system.

10. The method of claim 9, further comprising:
reacting the at least one formaldehyde with the at least one phenol and/or the at least one substituted phenol to obtain the at least one reaction product prior to molding or forming the sole synthetic polymer into the piston body of the resin-based electronic parking brake piston.

11. The method of claim 9, further comprising:
incorporating the resin-based electronic parking brake piston into the electromechanical parking brake system.

12. The method of claim 11, further comprising:
moving the resin-based electronic parking brake piston within a caliper bore of the electromechanical parking brake system.

13. The method of claim 9, wherein the piston body is shaped and/or sized to be disposed or received within a caliper bore of the electromechanical parking brake system.

14. The method of claim 13, further comprising:
disposing the resin-based electronic parking brake piston within the caliper bore of the electromechanical parking brake system.

15. The method of claim 9, wherein the sole synthetic polymer material is at least one glass filled molding or moldable material, at least one mineral filled molding or moldable material, or at least one combination thereof.

16. A method comprising:
disposing a resin-based electronic parking brake piston within a caliper bore of an electromechanical parking brake system, wherein the resin-based electronic parking brake piston comprising:
a piston body made of a sole synthetic polymer material consisting of at least one reaction product obtained by reacting at least one formaldehyde with at least one phenol and/or at least one substituted phenol,
at least one internal contact area disposed on the piston body and configured for contacting at least one spindle nut of the electromechanical parking brake system, and
at least one outer surface disposed on the piston body and configured to be slidable within at least one caliper bore of at least one electromechanical parking brake system.

17. The method of claim 16, further comprising:
contacting the at least one internal contact area with the at least one spindle nut or sliding the piston body within the at least one caliper bore via the at least one outer surface.

18. The method of claim 16, further comprising:
activating or deactivating the resin-based electronic parking brake piston.

19. The method of claim 16, further comprising:
moving the resin-based electronic parking brake piston within the caliper bore.

20. The method of claim 16, wherein the sole synthetic polymer material of the piston body is at least one glass filled molding or moldable material, at least one mineral filled molding or moldable material, or at least one combination thereof.
